(19) United States
(12) Patent Application Publication
(10) Pub. No.: US 2005/0264649 A1
(43) Pub. Date: Dec. 1, 2005

(54) Mobile video-interpreting mounting system

(76) Inventors: Calvin Chang, (US); Daniel Kurywchak, (US); Thomas Nesbitt, (US); David Oakes, (US); Robert Chason, (US); George Wu, (US)

Correspondence Address: FENWICK & WEST LLP, SILICON VALLEY CENTER, 801 CALIFORNIA STREET, MOUNTAIN VIEW, CA, 94041, US

(21) Appl. No.: 11/093,752

(22) Filed: Mar. 29, 2005

Related U.S. Application Data
(60) Provisional application No. 60/557,725, filed on Mar. 29, 2004.
(60) Provisional application No. 60/557,726, filed on Mar. 29, 2004.

(51) Int. Cl. H04L 12/16

(52) U.S. Cl. 348/14.12

(57) ABSTRACT

A device attaches a videoconferencing device to a mobile support structure to create a mobile videoconferencing apparatus for use in video-based interpretation of communications between a health care provider and a patient. A related system includes a attachment portion and a bracket apparatus fitted to receive and secure the attachment portion and support a videoconferencing device for receiving videoconferencing signals sent by an interpreter to a patient responsive to communications between the patient and a health care provider on a mobile support structure.

### CROSS REFERENCE TO RELATED APPLICATIONS

This application claims the benefit of U.S. provisional applications 60/557,725 and 60/557,726 each of which was filed Mar. 29, 2004 and each of which is hereby incorporated by reference in its entirety; this application is related to U.S. Patent Application entitled “Providing Video Interpreting Services,” filed Mar. 29, 2005, Attorney Docket 23540-9941, which is hereby incorporated by reference in its entirety.

### BACKGROUND

1. Field of the Invention

The present invention relates in general to telemedicine, and in particular to mobile devices for providing medical translation services.

2. Background of the Invention

The diversification of the population has brought an influx of patients that require interpreters to communicate with their health care providers into the doctor's office, operating room, and other health care settings. It is commonly the case that enterprise resources devoted to translation services, if any, are stretched thin. Hiring interpreters on a case-by-case basis is extremely costly and inefficient, with travel and wait time consuming the bulk of an interpreter's time commitment. In addition, the presence of an interpreter can make it harder for a patient to develop trust for a doctor or health care provider, especially when the patient perceives the translator as an advocate rather than a neutral third party, as is often the case. Videoconferencing, through which a translator in a remote location can interpret between a patient and a provider, addresses many of these problems.

Existing videoconferencing systems are poorly adapted to service such needs. Because videoconferences often involve multiple participants, displays are often large and used in venues such as conference rooms. In medical settings, however, space is often at a premium and privacy is of paramount concern, making large displays impractical and unnecessary. In addition, videoconferencing equipment, whether consisting of a specialized device or a computer, is typically designed for use in fixed locations, for instance mounted to a wall or in a desktop setting, whereas video-interpreting displays typically need to be shared across rooms. While mobile carts and other portable apparatus are available for health care settings, there is no easy way to modify existing videoconferencing systems, which are designed for fixed environments, for use with such apparatus. Thus what is needed is a way to make adapt existing videoconferencing systems for use in health care interpretation contexts.

### SUMMARY OF THE INVENTION

Embodiments of the present invention overcome the limitations of the prior art by providing a way to mount videoconferencing equipment to a mobile support structure. The result is a mobile videoconferencing apparatus can be easily maneuvered and transported depending on interpretation needs and consumes less space than conventional videoconferencing systems. While embodiments of the invention are described in the context of on-demand translation services in health care contexts, they can also be advantageously deployed in a variety of contexts and industries.

In one embodiment, a system for attaching a videoconferencing device to a mobile support structure is provided. The system comprises an attachment portion and a bracket apparatus fitted to receive and secure the attachment portion. The attachment portion is configured to mount a videoconferencing device on a mobile support structure. The videoconferencing device includes a display, microphone, camera, speaker, and network interface. The network interface allows videoconferencing signals to be received by a patient which are sent by an interpreter responsive to communications between the patient and a health care provider.

Another embodiment of the present invention comprises an apparatus for attaching a videoconferencing device to a mobile support structure to create a mobile videoconferencing unit. The apparatus comprises an attachment portion, means for affixing the attachment portion to the videoconferencing device, and means for securing the attachment portion to a bracket system attached to a mobile support structure.

### BRIEF DESCRIPTION OF THE DRAWINGS

FIG. 1 depicts a mobile videoconferencing base unit adapted for use in a health care enterprise in accordance with an embodiment of the invention.

FIGS. 2A-2C show various views of an exemplary system for attaching a videoconferencing device to a mobile support structure in accordance with an embodiment of the invention.

FIG. 3 shows a videoconferencing device in accordance with an embodiment of the invention.

FIG. 4 shows a mounting plate for securing a videoconferencing unit to a mobile support structure in accordance with an embodiment of the invention.

### DETAILED DESCRIPTION OF THE PREFERRED EMBODIMENTS

Reference will now be made in detail to several embodiments of the present invention(s), examples of which are illustrated in the accompanying figures. It is noted that wherever practicable, similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein. In addition, although features of the present disclosure are described in the context of health care interpretation teleconferencing, one of skill in the art will know that invention may also be adapted to other environments.

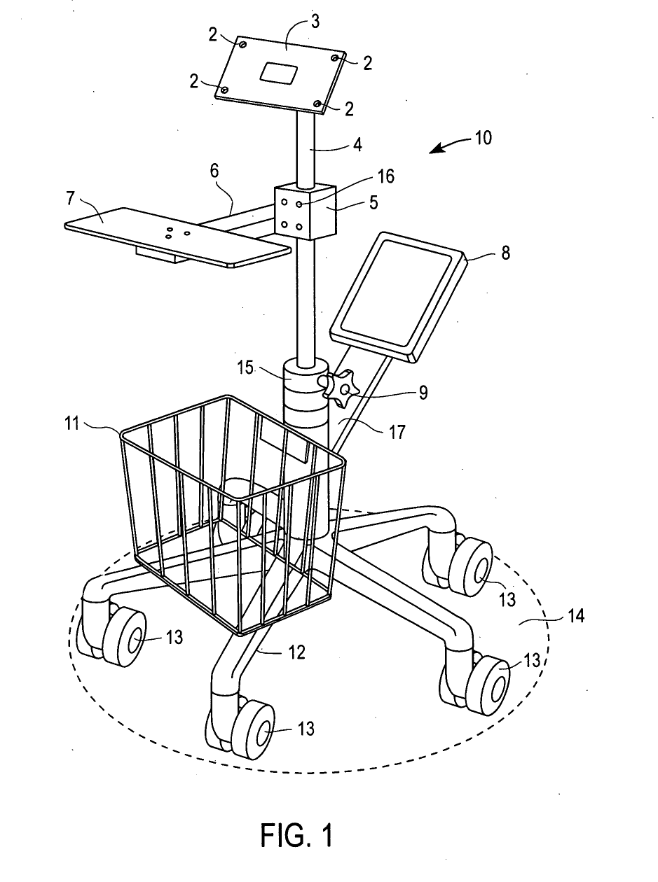

FIG. 1 depicts a mobile support structure adapted for use in a health care enterprise in accordance with an embodiment of the invention. A plate 3 provides a vertically oriented attachment surface for securing a videoconferencing display to a mobile support structure 10. A videoconferencing display such as a flat panel screen can be mounted to the plate 3 using a bracket or other attachment apparatus in order to create a mobile videoconferencing apparatus. The mobile support structure 10 includes a set of wheels 13 that allow the videoconferencing display to be easily maneuvered around a health care enterprise from one health care setting to another. The resulting mobile videoconferencing apparatus can be used to allow remote interpreters to interpret on behalf of patients and health care providers in clinical, treatment, intake, diagnostic test, rehabilitation, and administrative settings. Such an apparatus can be used in one or more of the systems described in U.S. Patent Application entitled “Providing Video Interpreting Services” and filed Mar. 29, 2005, Attorney Docket 23540-9941, incorporated by reference in its entirety above.

The apparatus has considerable advantages over conventional videoconferencing systems. The mobile support structure 10 has a small footprint 14, permitting it to be stored in small spaces when not in use. In an embodiment, portions or all of the mobile support structure 10 may be supplied by a conventional or adapted mobile medical equipment stand or rolling cart such as that offered by GCX, Inc. of Petaluma, Calif. In an embodiment, an adapted intravenous (IV) pole or other portable stand is used. In another embodiment, a videoconferencing system is fitted with an attachment system that can be used with multipurpose medical stands, carts, or other mobile support structures 10. Mobile support structure 10 allows videoconferencing equipment to be used like other conventional medical devices such as intravenous units or oxygen tanks, easing integration of the videointerpreting into existing workflows.

The mobile support structure 10 includes a vertical pole 4 secured into a fitted base 15 and mounted to a set of wheels 13. The vertical pole 4 can be made of metal, plastic, synthetic or other material. The pole 4 is installed in a fitted base 15, which may be adjusted to expand and contract in size by turning a tightening handle 9. After widening the circumference of the base 15, a user can adjust the length of the vertical pole 4, thereby raising or lowering the mobile videoconferencing display mounted thereon. In another embodiment, a gas foot pump, rather than the tightening handle 9 mechanism, could be used to support this functionality. In another embodiment, the pole 4 comprises a telescoping pole that is capable of extending to 5 feet. A horizontal support member 7 on which videoconferencing equipment can rest is coupled to the vertical pole 4, by way of an attachment arm 6 and a mounting member 5. In the mobile support structure 10 of FIG. 1, the mounting member 5 is formed permanently to the attachment arm 6, which is connected to the vertical pole 4 by a series of screws 15. However, other attachment mechanisms, including those that allow a user to adjust to the length and angle of attachment arm 6, may also be used. Mounting member 5 in turn is fixed to vertical pole 4 by a series of screws 16 that lock the front and back of mounting member 5 into place around vertical pole 4.

Vertical pole 4 terminates in attachment support 1, to which it can be welded or otherwise permanently or removably attached. Plate 3 comprises a surface to which a display can be mounted, by any variety of mechanisms. Pulling handle 8 attached to pulling arm 17 is coupled to base 15, and can be adjusted in angle using any standard lever, gear, or other mechanism. In other embodiments, the length of pulling arm 17 may also be adjusted. When mobile teleconferencing unit 10 is not being transported, pulling arm 17 can be put in an upright position, so as to minimize the space requirements associated with storing teleconferencing unit 10. A basket 11 is also attached to the base 15 of mobile teleconferencing unit 10. This basket 11 can be used to store, for instance, documentation such as a use log or user manual, or peripheral devices for videoconferencing including various connectors, power supplies, and the like.

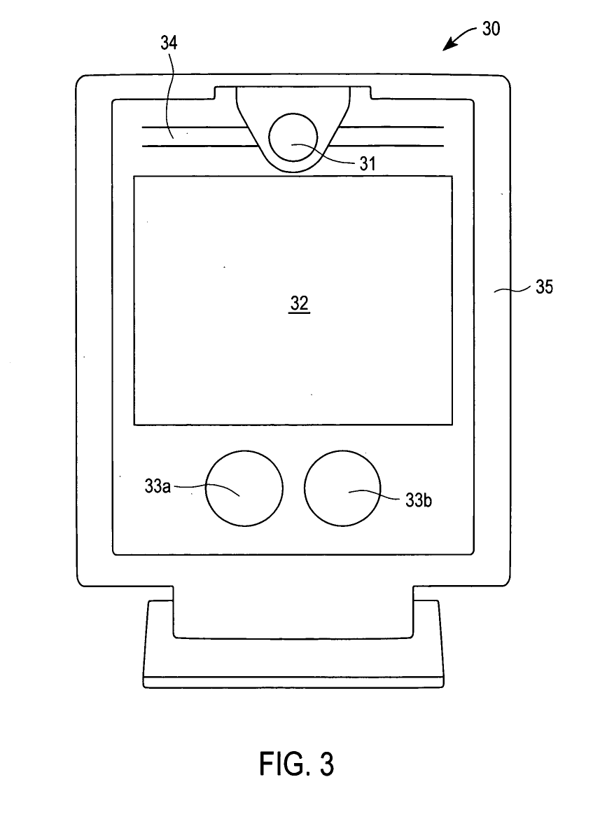

In an embodiment, a videoconferencing device such as that illustrated in FIG. 3 and described in additional detail below, is mounted to mobile support structure 10. The base of the videoconferencing device rests on horizontal support member 7 and attachment arm 6. In another embodiment, the device relies solely on mounting screws 2 on the plate 3 for support. The videoconferencing device is attached to a bracket fitted for the plate 3 that is attached to the mobile support structure 10. A variety of conventional features and methods for securing a videoconferencing device to a mobile support structure 10 besides a plate 3 and bracket could also be used. A display could be placed on a mounting bracket, cage, or frame and then loosely secured with velcro or other straps, for instance. In another embodiment a mobile support structure 10 could include a handle or hook from which a videoconferencing device could be suspended. One of skill in the art would understand that in any attachment system that includes complimentary parts, the two parts could be placed interchangeably on any of the elements being attached, in this case, the mobile structure support 10 and the videoconferencing device 30. For instance, for a bracket system that includes a plate 3, the plate 3 could be mounted to the mobile support structure 10, and then secured to a bracket system attached to the device. Just as easily, however, a bracket could be mounted to the device, and be configured to receive a plate 3 attached to the display.

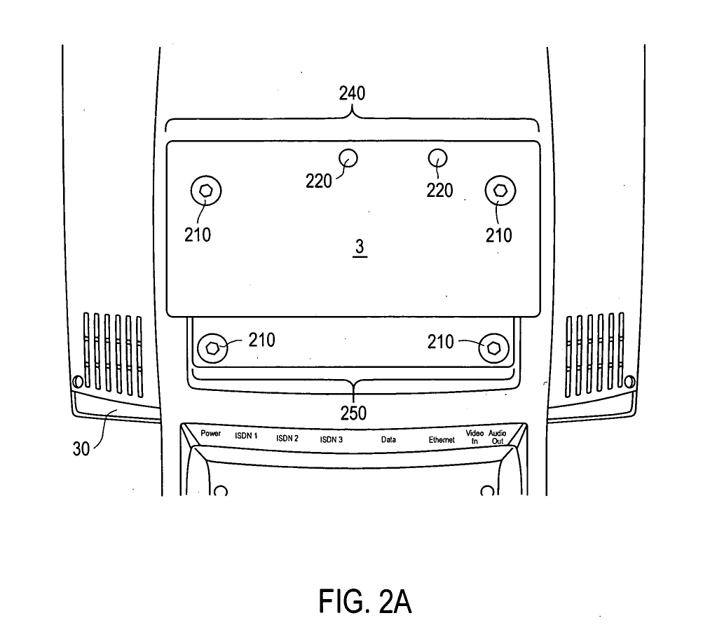

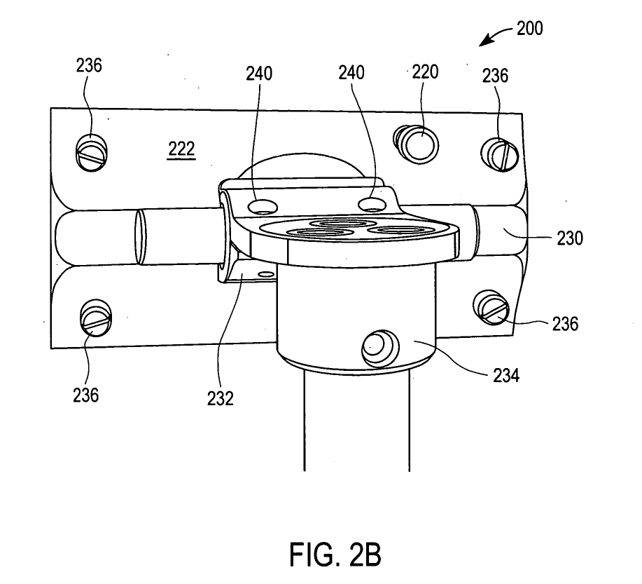

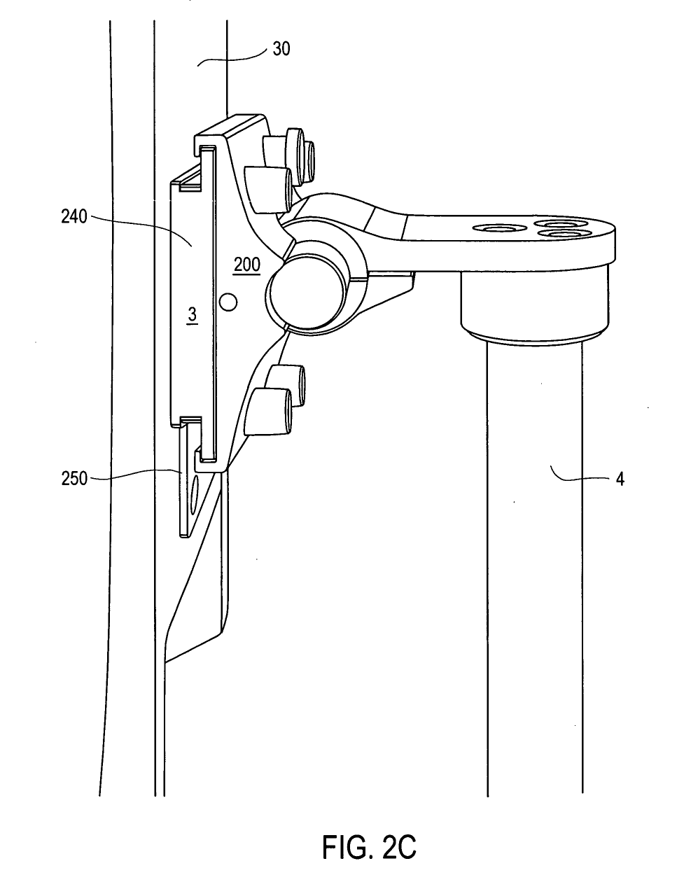

FIGS. 2A-2C show various views of an exemplary system for attaching a videoconferencing device to a mobile support structure in accordance with an embodiment of the invention. FIG. 2A shows a plate 3 attached to the back of a videoconferencing device 30. FIG. 2B is a back view of a bracket apparatus 200 fitted to receive a portion of the plate 3 of FIG. 2A, thereby securing the plate 3 to a mobile support structure such as the mobile support structure of FIG. 1. FIG. 2C shows a side view of a plate 3 attached to the back of a videoconferencing device 30 and secured in a bracket apparatus 200 mounted to a pole 4 of a mobile support structure.

The plate 3 of FIG. 2A can be used to secure a videoconferencing device 30 to a mobile support structure 10. The plate 3 is comprised of an attachment portion 240 that provides a surface of attachment for a bracket system attached to the mobile support system 10. The plate 3 also includes a base portion 250 that supports attachment of the plate 3 to a videoconferencing device 30. A side view of the attachment portion 240 installed into a bracket system 200 is shown in FIG. 2C. As can be seen from FIG. 2C, the attachment portion 240 of the plate 3 secures the videoconferencing device 30 to the bracket system 200 of a mobile support structure, while the base portion 250 affixes the plate 3 to the videoconferencing device 30. The plate 3 may be carved out of a solid block of metal or alloy or otherwise comprise a continuous element, or the plate 3 may be constructed in separate pieces (the base portion 250 and the attachment portion 240, for instance) that are later fused or welded together.

As shown, the base portion 250 of the plate of FIG. 2A is adapted to fit into the back of a videoconferencing display, in this case the videoconferencing display of the Tandberg 1000 system made by Tandberg Corp. of Oslo, Norway. In turn, the attachment portion 240 is designed to work with a bracket system, in the case of FIG. 2A, a bracket system provided by GCX, Inc. However, one or more of design dimensions or elements may be driven by other interfaces in various embodiments of the invention. For instance, a plate 3 could be devised to be compatible with an interface in compliance with a Video Electronics Standards Association (VESA) standard for flat-panel displays. The plate 3 may be designed to conform to other public or proprietary standards or interface specifications.

The plate 3 of FIG. 2A includes a series of four threaded holes 210, each for receiving an Allen screw to connect the plate 3 to the videoconferencing device 30. The plate 3 also includes two additional through holes 220 for interacting with a locking mechanism on a bracket for securing and attaching the plate 3 to the bracket. A hole 220 can be lined up with a corresponding hole on a bracket and the alignment secured with a quick release peg inserted into the holes on the bracket and plate 3, for instance. Such a locking system provides an additional support point to supplement the support provided by the bracket system 200 to the plate 3 when it is installed therein. In addition to the secure fit between the bracket system and plate 200, and the locking system described, any of a variety of mechanisms for securing the attachment portion 240 to the mobile support structure 10 using securing structures such as hooks, screws, bolts, frames, or other structures could be used. The plate 3 of FIG. 2A includes two offset holes 220. This allows for the plate 3 to be aligned with a bracket system in at least two positions. Other means for securing the attachment portion 240 to the bracket system in various positions may be used including through the use of notch, mechanical presets, ratchet, and like apparati.

FIG. 2B is a back view of a bracket apparatus 200 fitted to receive and secure the attachment portion 240 of the plate 3 of FIG. 2A. The bracket 200 includes a series of threaded holes designed to receive plastic pegs 236 that may be used as an additional securing mechanism to connect the bracket 200 and plate 3. As shown in FIG. 2C, the plastic pegs can be inserted in the bracket 200 to eliminate any play between the bracket 200 and plate 3 when installed. The bracket apparatus 200 includes a pivot shaft 230 around which the bracket portion 222 of the bracket apparatus 200 can rotate. This is useful for video-interpreting contexts when a patient or care provider may be alternatively sitting and standing during the course of the appointment and want to maintain a connection to the interpreter providing interpreting services to their interaction. A tilt control system 232 is included that can control the amount of tilt. In one embodiment, the tilt mechanism is provided by a series of Allen screws 240 that are tightened around a pivot shaft 230, which is in turn held in place by two torx screws. The Allen screws 240 are tightened just enough to allow tilt by lifting or pulling down on the videoconferencing unit. In another embodiment, a wing screw is used to allow a user to grip and turn the screw to secure the device in place. The tilt control system 232 could also comprise a gas spring-assisted mechanism for controlling movement. Any of a variety of additional or supplemental apparatus can be used, including a motor, ball-bearings, precision elements, and spring loaded elements.

FIG. 3 shows a videoconferencing device 30 for being mounted on mobile support structure 10 in accordance with an embodiment of the invention. The device 30 comprises a display 32, video camera 31, set of speakers 33, and microphone 34 integrated into a single device and stored in a shared housing or housing portion 35. In a preferred embodiment, also integrated into the videoconferencing device 30 is a high-quality compression decompression (CODEC) module and a networking interface, such as an Ethernet or wireless network card, that allows audio and video signals to be sent and received from wireless (802.11) and/or wired networks. The device 30 of FIG. 3 comprises the Tandberg 1000 videoconferencing unit. Other specialized units, made by other manufacturers including Polycom Corp. of Pleasanton, Calif., may also be used.

As shown, the display 32 comprises a built-in LCD flat screen, however in other embodiments, conventional cathode ray tube (CRT), LCD passive matrix, or other monitors may also be used. During a videoconferencing session, video camera 31 can be adjusted to pan or tilt towards a speaker automatically or manually, including by using a remote control (not shown). Audio sound is captured by the microphone 34, and video data from the video camera 31 and transmitted over a network (not shown) to an interpreter at a remote site. The image of the interpreter, in turn, is displayed on display 32, and the voice of the interpreter is broadcast over one or more speakers 33. The embedded camera 31 of the videoconferencing device 30 is unobtrusive, making the patient less self-conscious about their communications with the interpreter. Furthermore, the camera 31, with a small lens, can be easily covered, preventing the translator from viewing an image of the patent, if the patient would like confidentiality, for instance, during a physical examination portion of the visit. In an embodiment, an opaque sleeve is provided that can be easily slid or placed over the camera lens at such moments.

Although videoconferencing device 30 of FIG. 3 shows a single device that integrates a number of functionalities, in other embodiments, a non-specialized, general display and networking connection may be used. For instance, a desktop or laptop personal computer (PC) and monitor with various webcam, speaker, microphone, and other peripherals may be used. In an embodiment, a computer and peripherals could be mounted to a support surface, each element secured using Velcro or other method. Persons of ordinary skill in the art will know that other conventional approaches to supplying videoconferencing services may also be used. In addition, in an embodiment, videoconferencing device 30 is powered by Lithium Hydride, Nickel Hydride, rechargeable, or other conventional or emerging battery technologies, and uses wireless technology to receive and send videoconferencing data. However, in another embodiment the unit is plugged into an electrical outlet, or is coupled to a wireline connection, in order to transmit and receive audio and video data.

Before the videoconferencing device 30 is mounted to a mobile support structure 10, it must be adapted to be attached to a plate or other attachment structure. The videoconferencing device 30 comprises a housing portion 35, the chassis or shell of the device, and an electronics portion comprising for instance a CODEC, motherboard, display electronics, processor, and other such elements. In an embodiment, a portion of the chassis 35 is removed or otherwise isolated from the device electronics. Holes corresponding to the holes on the plate or other attachment structure are drilled, tapped, and threaded, and the plate is screwed thereupon.

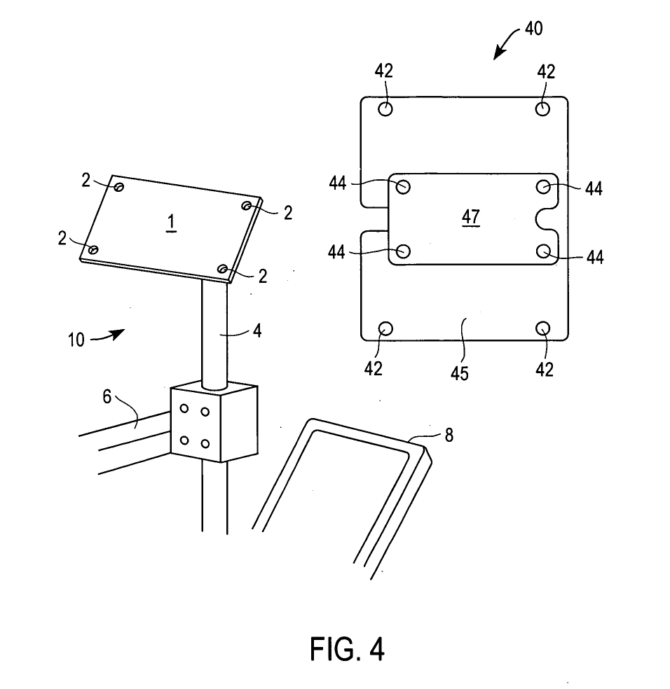

FIG. 4 shows a mounting plate 40 for securing a videoconferencing unit, such as the videoconferencing unit of FIG. 3, to the mobile support structure 10 of FIG. 1. The mounting plate 40 provides an alternative structure to the plates 3 shown in FIGS. 2A-2C and can mount to a mobile support structure 10 as well as to a wall mount system. The mounting plate 40 comprises two sections, a wall mount bracket 45 and a custom-made attachment plate 47. The wall mount bracket 45 comprises a conventional bracket used to mount a display or videoconferencing unit to a wall. In an embodiment, the wall mount bracket 45 comprises a standard issue Tandberg Wall Mount bracket adapted for use with the Tandberg 1000 videoconferencing display unit. The wall mount bracket 45 attaches to the back of a videoconferencing unit by way of screw holes 42. Attachment plate 47 in turn is attached to wall mount bracket 45. In an embodiment, attachment plate 47 is welded to wall mount bracket 45, alternatively it may be attached by screws or other conventional mechanical attachment mechanisms. Attachment plate 47 can be secured to a mobile support structure. In an embodiment, attachment plate 47 can be mounted to attachment support 1, by way of screw holes 2 & 44. As shown, wall mount bracket 45 and attachment plate 47 are directly attached to each other, however in other embodiments, they may be configured or integrated differently. Wall mount bracket 45, with attachment plate 47 attached to it, is secured to the back of a video display (not shown). The entire mechanism is mounted to mobile support structure 10, and secured in place by connecting attachment plate 47 to attachment support 1 by screw holes 2 & 44. In other embodiments, the mounting plate 40 includes any of a variety of means for attaching the plate 40 to a wall or other videoconferencing support unit as well as to a mobile support structure. These means may comprise standard or proprietary attachment systems.

The above description is included to illustrate the operation of the certain embodiments and is not meant to limit the scope of the invention. From the above discussion, many variations will be apparent to one skilled in the relevant art that would yet be encompassed by the spirit and scope of the invention.

1. A system for attaching a videoconferencing device to a mobile support structure, the system comprising:
a attachment portion; and
a bracket apparatus fitted to receive and secure the attachment portion and configured to mount the videoconferencing device on a mobile support structure, the videoconferencing device comprising an integrated display, microphone, camera, and network interface, the network interface for receiving videoconferencing signals sent by an interpreter to a patient responsive to communications between the patient and a health care provider.

2. The system of claim 1, wherein the bracket apparatus is attached to the mobile support structure and the attachment portion is attached to the videoconferencing device.

3. The system of claim 1, wherein the bracket apparatus is attached to the videoconferencing device and the attachment portion is attached to the mobile support structure.

4. The system of claim 1, wherein the bracket apparatus comprises a bracket portion and a pivot shaft wherein the bracket portion is configured to tilt around the pivot shaft.

5. The system of claim 4, further wherein the bracket apparatus further comprises a tilt control system for stabilizing the bracket apparatus in a plurality of tilt positions.

6. The system of claim 1, wherein the bracket apparatus includes a hole for receiving a quick release peg for attaching the attachment portion to the bracket apparatus.

7. The system of claim 1, further comprising a locking mechanism for securing the attachment portion to the bracket apparatus in at least two positions.

8. The system of claim 1, wherein the mobile support structure comprises a telescoping pole.

9. The system of claim 1, wherein the attachment portion comprises a portion fitted to be received by an attachment system for mounting the videoconferencing device to the wall.

10. A method of adapting a videoconferencing device to be mounted to a mobile support structure, the method comprising:
providing a plate, a portion of the plate adapted to be slidably received into and secured to a bracket apparatus of a mobile support structure, the bracket apparatus comprising a locking mechanism for detachably securing the plate to the mobile support structure; and
attaching the plate to a videoconferencing device with at least one connecting structure, the videoconferencing device comprising an integrated display, microphone, speaker, camera, and interface for receiving communications from an interpreter to a patient.

11. The method of claim 10, further comprising providing an attachment apparatus for mounting the videoconferencing device to a wall.

12. The method of claim 10, wherein the step of providing comprises providing the plate in accordance with an interface standard.

13. The method of claim 12, wherein the interface standard comprises a display interface standard.

14. The method of claim 10, wherein the locking mechanism comprises a threaded hole corresponding to a threaded hole in the plate, the threaded holes for receiving a peg for coupling the bracket apparatus and the plate.

15. The method of claim 10, further comprising adapting the videoconferencing device for attachment to the plate.

16. The method of claim 15, wherein the videoconferencing device comprises a housing portion and an electronics portion and further comprising:
isolating a housing portion of the videoconferencing device from an electronics portion of the videoconferencing device;
creating openings in the housing portion for receiving the at least one connecting structure for attaching the plate to the videoconferencing device.

17. An apparatus for attaching a videoconferencing device to a mobile support structure to create a mobile videoconferencing unit for use in video-based interpretation of communications between a health care provider and a patient, the apparatus comprising:
an attachment portion;
means for affixing the attachment portion to the videoconferencing device, the videoconferencing device comprising a display, microphone, speaker, camera, and interface, the interface for transmitting and receiving videoconferencing signals; and
means for securing the attachment portion to a bracket system attached to a mobile support structure.

18. The apparatus of claim 17, further wherein the bracket system comprises means for securing the attachment portion to the bracket system in at least two positions.

19. The apparatus of claim 17, comprising means for tilting the attachment portion when the attachment portion is secured to the bracket system.

20. The apparatus of claim 17, wherein the bracket system comprises means for securing the tilt of the attachment portion in a variety of tilt positions.
